(19) United States
(12) Patent Application Publication
(10) Pub. No.: US 2022/0253653 A1
(43) Pub. Date: Aug. 11, 2022

(54) COLOR PRINTING CALIBRATION

(71) Applicant: Hewlett-Packard Development Company, L.P., Spring, TX (US)

(72) Inventor: Miguel Angel Lopez Alvarez, Vancouver, WA (US)

(73) Assignee: Hewlett-Packard Development Company, L.P., Spring, TX (US)

(21) Appl. No.: 17/432,996

(22) PCT Filed: Jun. 25, 2019
(86) PCT No.: PCT/US2019/038886

§ 371 Date: Aug. 23, 2021

(51) Int. Cl. G06K 15/02; H04N 1/60

(52) U.S. Cl. CPC G06K 15/027; H04N 1/60

(57) ABSTRACT

Aspects of the present disclosure relate to color printing calibration. In a particular example, an apparatus includes an output circuit to print a color target for a particular lot of printing material, a calibration circuit, and an identifier circuit. The calibration circuit may identify color values for the color target, determine a plurality of color correction values for the particular lot of printing material based on the identified color values, and generate a color corrections map including the determined color correction values for the particular lot of printing material. The identifier circuit may generate an identifier corresponding with the color corrections map, identifying a location of the color corrections map in a network-accessible table for retrieval and calibration of printing devices using the particular lot of printing material.

### BACKGROUND

Color calibration in color printers may improve the consistency of color output over time, and the consistency of color output from printer to printer, or page to page, as well. The color calibration for different printing temperatures may also impact the consistency of color output. The parameters that can lead a printer to deliver colors differently than expected are manifold may include humidity, temperature variations in the print heads, or slightly different substrate chemical properties, among many others.

### BRIEF DESCRIPTION OF FIGURES

Various example may be more completely understood in consideration of the following detailed description in connection with the accompanying drawings, in which:

FIG. 1 is a diagram illustrating an example apparatus for color printing calibration, in accordance with the present disclosure;

FIG. 2 is a diagram illustrating an example system for color printing calibration, in accordance with the present disclosure; and

FIG. 3 is a diagram illustrating an example computing apparatus for color printing calibration, in accordance with the present disclosure.

While various examples discussed herein are amenable to modifications and alternative forms, aspects thereof have been shown by way of example in the drawings and will be described in detail. It should be understood, however, that the intention is not to limit the disclosure to the particular examples described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION

Aspects of the present disclosure applicable to a variety of different systems and methods for color printing calibration, including for example, an apparatus including an output circuit, a calibration circuit, and a identifier circuit. As examples, the output circuit may print a color target for a particular lot of printing material, and the calibration circuit may identify color values for the color target, determine a plurality of color correction values for the particular lot of printing material based on the identified color values, and generate a color corrections map, where the color corrections map includes the determined color correction values for the particular lot of printing material. As a further example, the identifier circuit may generate a barcode corresponding with the color corrections map, wherein the barcode identifies a location of the color corrections map in a network-accessible table for retrieval and calibration of printing devices using the particular lot of printing material.

While not necessarily so limited, various aspects may be appreciated from the following disclosure which uses some of the above examples. In some applications, such examples are advantageous in that by generating a color corrections map that contains information about the amount of printing materials or colorants to be used for printing, a color image may improve color consistency between pages and between printers. In general terms, color corrections maps may be used to establish a relationship between color spaces, which can be red-green-blue (RGB), cyan-magenta-yellow (CMY), among others. Additionally, color corrections maps may be used for printers which use more than three printing material colors.

As discussed herein, a calibration circuit and an associated identifier circuit may be used to calibrate printing devices relative to a color corrections map that is generated for a particular lot of printing material. In such example contexts, a color corrections map refers to or includes a database such as a look-up table as stored in a memory circuit, data-accessible register or other non-transient medium. The color corrections map may be generated by printing by printing a color target containing a representative set of available colors that can be produced by the printer. Once the color corrections map is created, an identifier may be assigned to the color corrections map. The identifier and the color corrections map may be stored in a network location for subsequent retrieval, for example, by the identifier circuit. At printing time, the color corrections map may be retrieved from the network location, such as via a network-connected device, and values from the color corrections map may be applied to the printer to calibrate the printer for that particular printing material lot. While in some examples, the printing material may be ink, examples are not so limited and other printing materials are contemplated by the present disclosure. For instance, the printing material may include without limitation, toner, 3-D printing materials such as acrylonitrile butadiene styrene (ABS), polylactic acid (PLA), polyvinyl alcohol (PVA), Nylon, High-density polyethylene (HDPE), polyethylene terephthalate (PETT), wood filament, metal filament, carbon fiber, flexible filament, and conductive filament, and thermal paper, among others.

In the following description various specific details are set forth to describe specific examples, with the understanding that other examples may be practiced without all the specific details given below and that features from figures/example can be combined with features of another figure or example even though the combination is not explicitly shown or explicitly described as a combination. For ease of illustration, the same reference numerals may be used in different diagrams to refer to the same elements or additional instances of the same element. Specific details are given in the following description to provide a thorough understanding of examples while appreciating that examples may be practiced without such specific details and that other details may not be shown to avoid obscuring discussion of certain examples.

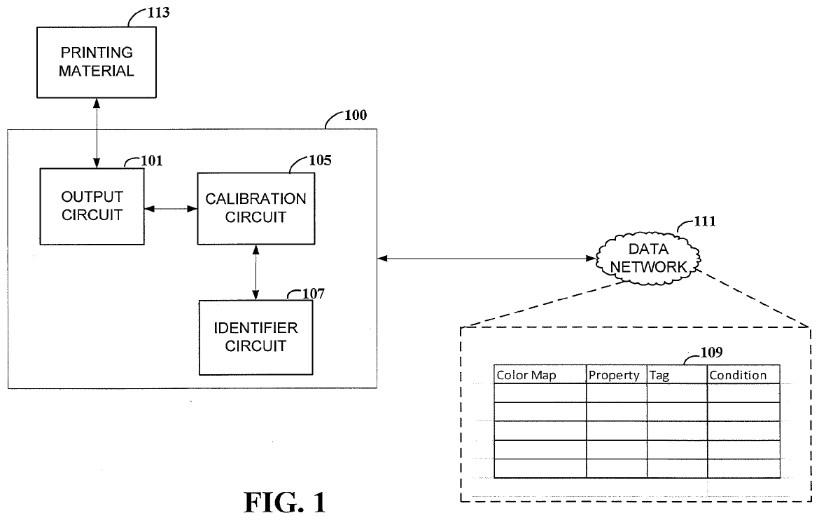

Turning now to the Figures, FIG. 1 is a diagram illustrating an example apparatus for color printing calibration, in accordance with the present disclosure. In this example, print color transforms may be dependent on a particular printing material, and color corrections maps are generated for the particular printing material. In other specific examples, such color corrections maps are generated along with the printer inks or toners, and optionally also included with printer firmware or a printer driver.

Examples may include an architecture where the printer may contain color corrections and/or modifications, which are used in conjunction with data from the printer cartridge to formulate printer-specific color transforms.

In one specific example, an apparatus 100 for color printing calibration includes an output circuit 101 to print a color target for a particular lot of printing material, a calibration circuit 105, and an identifier circuit 107. The calibration circuit 105 may identify color values for the color target, determine a plurality of color correction values for the particular lot of printing material 113 based on the identified color values, and generate a color corrections map, wherein the color corrections map includes the determined color correction values for the particular lot of printing material. The identifier circuit 107 may generate a barcode corresponding with the color corrections map, wherein the barcode identifies a location of the color corrections map in a network-accessible table for retrieval and calibration of printing devices using the particular lot of printing material.

As an illustration, the output circuit 101 may print a color target for a particular lot of the printing material 113 on a print target. The print target refers to or includes paper, zero-ink paper which contains colorants that can be selectively activated with relatively high temperatures, as well as substrates for three-dimensional (3-D) printing. The output circuit 101 may print the color target by printing a representative set of colors that are capable of being printed by the apparatus. Responsive to printing the color target on the print target, the calibration circuit 105 may use a colorimeter or other measuring device to identify color values for the color target. The calibration circuit 105 may determine the color correction values for each of the representative set of colors included in the color target. Responsive to measurement of the color values, the calibration circuit 105 may determine a plurality of color correction values for the particular lot of printing material based on the identified color values. As used herein, the color correction values refer to or include information about an amount of colorant to be used for printing a color image. The calibration circuit 105 may further generate a color corrections map, including the determined color correction values for the particular lot of printing material 113.

The identifier circuit 107 may generate an identifier corresponding with the color corrections map that identifies a location of the color corrections map in a network-accessible table 109 for retrieval and calibration of printing devices using the particular lot of printing material 113. The network-accessible table 109 may index a plurality of color corrections map selection fields to a plurality of color corrections maps. The plurality of color corrections maps may be based on the collected color data. Each entry of the network-accessible table 109 may include an identifier to match one of the plurality of color corrections maps to at least one permutation of the color corrections map selection fields.

Thus, examples of the present disclosure may provide a network-accessible system for accessing individual color corrections maps, calculated on a lot-by-lot basis, that are generated at the end of the printing material manufacturing line. By printing a set of color targets that would sample the whole printing material color space (and not just 7 ramps from white to CMY+RGB+black), and measuring them with a spectrophotometer, the printer color corrections map can be calculated for every manufactured printing material lot. The color corrections map contains complete color information of the printing material being manufactured. Additionally, since the color corrections map may contain around 300 kilobytes of information, a barcode may be used as a pointer to a data network 111 storage location (e.g., table 109) that contains the complete color corrections map for every manufactured print target lot. Once the barcode is read, the corresponding color corrections map is downloaded to a network-accessible device such as a mobile phone, and the color corrections map is applied to the image before printing.

In some examples, the identifier circuit 107 may store the network-accessible table 109, in a cloud storage location, such as that accessible by data network 111. The network-accessible table 109 may index a plurality of color corrections map selection fields to a plurality of color corrections maps. The plurality of color corrections maps may be based on the collected color data. Each entry of the network-accessible table 109 may include a barcode to match one of the plurality of color corrections maps to at least one permutation of the color corrections map selection fields.

As explained above, a color corrections map may be used to correct and/or calibrate the color output for a particular lot of printing material.

In one example, a color corrections map may correspond to a particular printing material type. For instance, particular paper types, or particular paper colors may have corresponding color corrections maps. One color corrections map may correspond to plain paper and another color corrections map may correspond to thicker paper, such as company letterhead, or bond paper. In another example, different degrees of output quality may have different color corrections map. For example, a “draft” quality may have one color corrections map, and a “best” quality may have a different color corrections map.

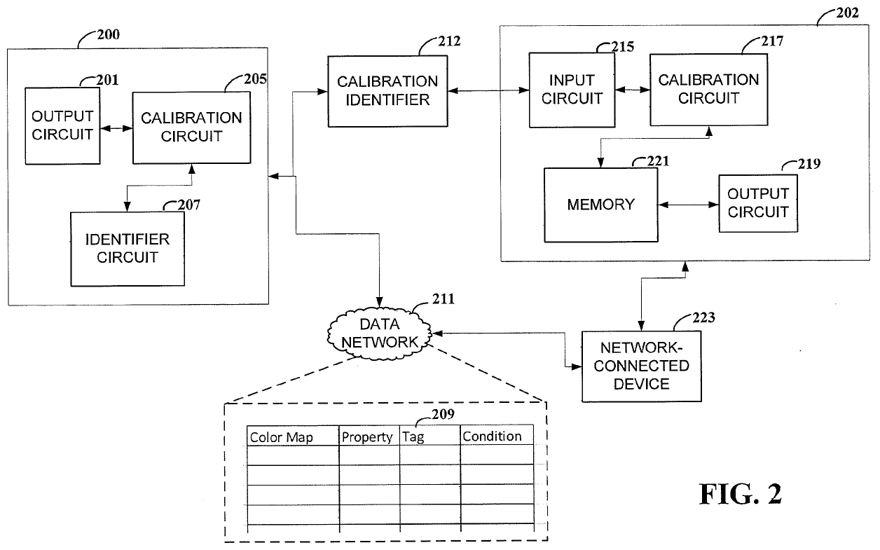

FIG. 2 is a diagram illustrating an example system for color printing calibration, in accordance with the present disclosure. As illustrated in FIG. 2, the system may include a first apparatus 200 and a second apparatus 202. The first apparatus 200 of FIG. 2 may respectively include at least the functionality and/or hardware of the apparatus 100 of FIG. 1.

For instance, the first apparatus 200 may include an output circuit 201 to print a color target for a particular lot of printing material, a calibration circuit 205, and an identifier circuit 207. The calibration circuit 205 may identify color values for the color target, determine a plurality of color correction values for the particular lot of printing material based on the identified color values, and generate a color corrections map, including the determined color correction values for the particular lot of printing material. The identifier circuit 207 may generate a calibration identifier 212 corresponding with the color corrections map, identifying a location of the color corrections map in a network-accessible table 209 for retrieval and calibration of printing devices using the particular lot of printing material.

The second apparatus 202, as illustrated, may include an input circuit 215, a calibration circuit 217, a local memory 221, and an output circuit 219. The input circuit 215 may read a calibration identifier 212 for a particular lot of printing material, the calibration identifier corresponding with a location of a lot-specific color corrections map in a network-accessible table 209. For instance, the second apparatus 202 may be a printer with scanning capabilities, and the input circuit 215 may include a scanner capable of reading a calibration code 212. While calibration barcodes are referred to herein as examples of calibration identifiers for identifying a color corrections map in the table 209, examples are not so limited. For instance, additional and/or different calibration identifiers may be employed. As an illustration, QR codes, also called 2D codes, or other means may be used to encode information in the network-accessible table 209. A QR code can accommodate much more information that a barcode, and may allow for encryption of the associated information. In such examples, the color corrections map may be read directly from the QR codes, rather than being retrieved from the data network 211.

The second apparatus 202 may also include a calibration circuit 217. The calibration circuit 217 of the second apparatus 202 may, responsive to retrieval of the color corrections map from the network-accessible table 209, identify color correction values for the particular lot of printing materials. Additionally, the calibration circuit 217 of the second apparatus 202 may store in a local memory 221 of the apparatus 202, an association between the particular lot of printing material and the color correction values. In such a manner, the second apparatus 202 may retrieve the color correction values without accessing the network-accessible table 209 each time. The second apparatus 202 may further include an output circuit 219 to calibrate printing for the particular lot of printing material, responsive to retrieval of the color correction values from the local memory 221. For instance, the second apparatus 202, which may be a color printer, may adjust at least one level of color to calibrate the color output from the printer.

In some examples, the calibration circuit 217 of the second apparatus 202 may, responsive to receipt of the calibration identifier 212 from the input circuit 215, send the calibration identifier 212 to a network-connected device 223. For instance, in the example discussed above in which the second apparatus 202 is a color printer, the color printer may be communicatively coupled to a network-connected device 223 such as a mobile phone. The mobile phone may access an application or set of machine-readable instructions to store and/or retrieve calibration barcodes in/from the table 209. Accordingly, the calibration circuit 217 may send instructions to the network-connected device 223 to retrieve the color correction values from the network-accessible table 209 using the calibration identifier 212. The calibration circuit 217 may store in the local memory 221 of the second apparatus 202, the association between the particular lot of printing material and the color correction values, responsive to receipt of the color correction values from the network-connected device 223.

In various examples, the second apparatus 202 may store color correction values for different lots of printing material for subsequent retrieval. For instance, a first calibration identifier may be stored in memory 221, as well as a second calibration identifier. The input circuit 215 may read a second calibration identifier for a different lot of printing material, and the calibration circuit 217 may identify color correction values for the different lot of printing material. The output circuit 219 may calibrate printing for the second apparatus 202, in response to identification of the first calibration identifier or the second calibration identifier. In such a manner, the second apparatus 202 may automatically calibrate itself for a particular lot of printing material.

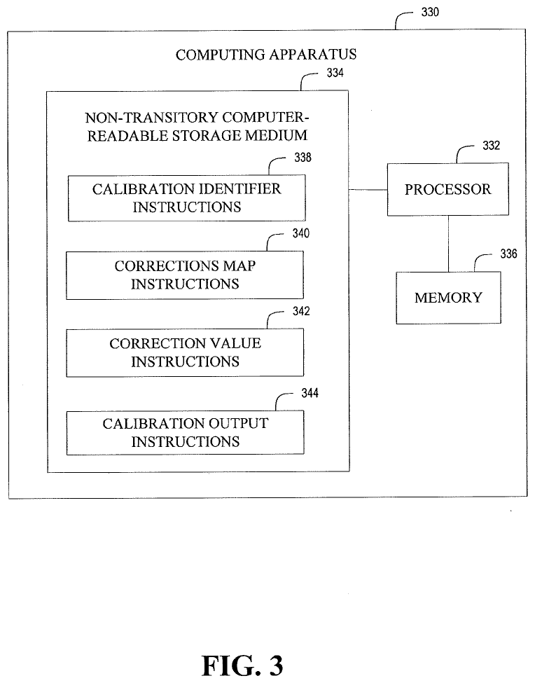

FIG. 3 is a diagram illustrating an example computing apparatus 330 for color printing calibration, in accordance with the present disclosure. In the example of FIG. 3, the computing apparatus 330 may include a processor 332 and a non-transitory computer-readable storage medium 334, and a memory 336. The non-transitory computer-readable storage medium 334 further includes instructions 338, 340, 342, and 344 for color printing calibration. The computing apparatus 330 may be, for example, a printer, a mobile device, a fax machine, multimedia device, a secure microprocessor, a notebook computer, a desktop computer, an all-in-one system, a server, a network device, a controller, a wireless device, or any other type of device capable of executing the instructions 338, 340, 342, and 344. In certain examples, the computing apparatus 330 may include or be connected to additional components such as memory, controllers, etc.

The processor 332 may be a central processing unit (CPU), a semiconductor-based microprocessor, a graphics processing unit (GPU), a microcontroller, special purpose logic hardware controlled by microcode or other hardware devices suitable for retrieval and execution of instructions stored in the non-transitory computer-readable storage medium 334, or combinations thereof. The processor 332 may fetch, decode, and execute instructions 338, 340, 342, and 344 to calibrate a color printer. As an alternative or in addition to retrieving and executing instructions, the processor 332 may include at least one integrated circuit (IC), other control logic, other electronic circuits, or combinations thereof that include a number of electronic components for performing the functionality of instructions 338, 340, 342, and 344.

Non-transitory computer-readable storage medium 334 may be an electronic, magnetic, optical, or other physical storage device that contains or stores executable instructions. Thus, non-transitory computer-readable storage medium 334 may be, for example, Random Access Memory (RAM), an Electrically Erasable Programmable Read-Only Memory (EEPROM), a storage device, an optical disc, etc. In some examples, the computer-readable storage medium 334 may be a non-transitory storage medium, where the term ‘non-transitory’ does not encompass transitory propagating signals. As described in detail below, the non-transitory computer-readable storage medium 334 may be encoded with a series of executable instructions 338-344. In some examples, non-transitory computer-readable storage medium 334 may implement a memory 336 to store and/or execute instructions 338-344. Memory 336 may be any non-volatile memory, such as EEPROM, flash memory, etc.

As illustrated, the non-transitory computer-readable storage medium 334 may store instructions 338 that, when executed, cause the computing apparatus 330 to receive from an input circuit, instructions corresponding with a calibration identifier for a particular lot of printing material. For instance, referring to FIG. 2, the calibration circuit 217 of the second apparatus 202 may receive from the input circuit 215, instructions corresponding to the calibration identifier 212.

The non-transitory computer-readable storage medium 334 may include instructions 340 that, if executed, cause the processor 332 to retrieve from a network-accessible table, a color corrections map corresponding with the calibration identifier. For instance, the computer-readable storage medium 334 may include instructions that, if executed, cause the processor 332 to identify a location of the color corrections map in the network-accessible table, such as table 209 illustrated in FIG. 2, responsive to receipt of the calibration identifier.

Additionally, the non-transitory computer-readable storage medium 334 may include instructions 342 that, if executed, cause the processor 332 to identify color correction values based on the retrieved color corrections map. For instance, referring to FIG. 2, color correction values may be retrieved from the network accessible table 209. Accordingly, the non-transitory computer-readable storage medium may instructions that, if executed, cause the processor 332 to retrieve the color corrections map from the network-accessible table, responsive to receipt of the calibration identifier from a network-connected printer.

Moreover, the non-transitory computer-readable storage medium 334 may include instructions 344 that, if executed, cause the processor 332 to provide instructions to an output circuit, including the color correction values to calibrate printing for the particular lot of printing material from the output circuit. For instance, referring to FIG. 2, instructions may be provided to output circuit 219 of the second apparatus 202 to calibrate printing for the particular lot of printing material. As such, the non-transitory computer-readable storage medium 334 may include instructions 344 that, if executed, cause the processor 332 to provide the instructions including the color correction values to the network-connected printer.

The skilled artisan would recognize that various terminology as used in the Specification (including claims) connote a plain meaning in the art unless otherwise indicated. As examples, the Specification describes and/or illustrates aspects useful for implementing the claimed disclosure by way of various structure, such as circuits or circuitry selected or designed to carry out specific acts or functions, as may be recognized in the figures or the related discussion as depicted by or using terms such as device, system, unit, controller, and/or other examples. See, e.g., reference numerals 100 of FIG. 1, and numerals 200 and 202 of FIG. 2. It will also be appreciated that certain of these blocks may also be used in combination to exemplify how operational aspects (e.g., steps, functions, activities, etc.) have been designed, arranged. Whether alone or in combination with other such blocks (or circuitry including discrete circuit elements such as transistors, resistors etc.), these above-characterized blocks may be circuits configured/coded by fixed design and/or by (re)configurable circuitry (e.g., CPUs/logic arrays/controllers) and/or circuit elements to this end of the corresponding structure carrying out such operational aspects. In certain examples, such a programmable circuit refers to or includes one or more computer circuits, including memory circuitry for storing and accessing a set of program code to be accessed/executed as instructions and/or (re)configuration data to perform the related operation, as may be used in carrying out a single step or a more complex multi-step algorithm. Depending on the data-processing application, such instructions (and/or configuration data) can be configured for implementation in logic circuitry, with the instructions (via fixed circuitry, limited group of configuration code, or instructions characterized by way of object code, firmware and/or software) as may be stored in and accessible from a memory (circuit).

As another example, where the Specification may make reference to a “first apparatus,” a “second apparatus,” etc., where the apparatus might be replaced with terms such as “circuit,” “circuitry” and others, the adjectives “first” and “second” are not used to connote any description of the structure or to provide any substantive meaning; rather, such adjectives are merely used for English-language antecedence to differentiate one such similarly-named structure from another similarly-named structure designed or coded to perform or carry out the operation associated with the structure.

Based upon the above discussion and illustrations, those skilled in the art will readily recognize that various modifications and changes may be made to the various examples without strictly following the exemplary examples and applications illustrated and described herein. For example, methods as exemplified in the Figures may involve steps carried out in various orders, with one or more aspects of the examples herein retained, or may involve fewer or more steps.

What is claimed is:

1. An apparatus, comprising:
an output circuit to print a color target for a particular lot of printing material;
a calibration circuit to:
identify color values for the color target;
determine a plurality of color correction values for the particular lot of printing material based on the identified color values; and
generate a color corrections map, wherein the color corrections map includes the determined color correction values for the particular lot of printing material; and
an identifier circuit to generate an identifier corresponding with the color corrections map, wherein the identifier identifies a location of the color corrections map in a network-accessible table for retrieval and calibration of printing devices using the particular lot of printing material.

2. The apparatus of claim 1, further including the identifier circuit to store the color corrections map in the network-accessible table.

3. The apparatus of claim 1, wherein the color corrections map includes information about an amount of colorant to be used for printing a color image.

4. The apparatus of claim 1, wherein the output circuit is to print the color target by printing a representative set of colors that are capable of being printed by the apparatus.

5. The apparatus of claim 4, wherein the calibration circuit is to determine the color correction values for each of the representative set of colors included in the color target.

6. An apparatus, comprising:
an input circuit to read a calibration identifier for a particular lot of printing material, wherein the calibration identifier corresponds with a location of a lot-specific color corrections map in a network-accessible table; and
a calibration circuit to:
responsive to retrieval of the color corrections map from the network-accessible table, identify color correction values for the particular lot of printing materials; and
store in a local memory of the apparatus, an association between the particular lot of printing material and the color correction values; and
an output circuit to calibrate printing for the particular lot of printing material, responsive to retrieval of the color correction values from the local memory.

7. The apparatus of claim 6, further including the calibration circuit to, responsive to receipt of the calibration identifier from the input circuit, send the calibration identifier to a network-connected device.

8. The apparatus of claim 7, further including the calibration circuit to send instructions to the network-connected device to retrieve the color correction values from the network-accessible table using the calibration identifier.

9. The apparatus of claim 7, further including the calibration circuit to store in the local memory of the apparatus, the association between the particular lot of printing material and the color correction values, responsive to receipt of the color correction values from the network-connected device.

10. The apparatus of claim 6, wherein the calibration identifier is a first calibration identifier, further including the input circuit to read a second calibration identifier for a different lot of printing material and the calibration circuit to identify color correction values for the different lot of printing material.

11. The apparatus of claim 10, further including the output circuit to calibrate printing for the apparatus, in response to identification of the first calibration identifier or the second calibration identifier.

12. A non-transitory computer-readable storage medium storing instructions that, if executed, cause a processor to:
receive from an input circuit, instructions corresponding with a calibration identifier for a particular lot of printing material;
retrieve from a network-accessible table, a color corrections map corresponding with the calibration identifier;
identify color correction values based on the retrieved color corrections map; and
provide instructions to an output circuit, including the color correction values to calibrate printing for the particular lot of printing material from the output circuit.

13. The non-transitory computer-readable storage medium of claim 12, further including instructions that, if executed, cause the processor to identify a location of the color corrections map in the network-accessible table, responsive to receipt of the calibration identifier.

14. The non-transitory computer-readable storage medium of claim 12, further including instructions that, if executed, cause the processor to retrieve the color corrections map from the network-accessible table, responsive to receipt of the calibration identifier from a network-connected printer.

15. The non-transitory computer-readable storage medium of claim 14, further including instructions that, if executed, cause the processor to provide the instructions including the color correction values to the network-connected printer.
